(19) United States
(12) Patent Application Publication
(10) Pub. No.: US 2025/0167471 A1
(43) Pub. Date: May 22, 2025

(54) CONNECTOR, CONNECTOR MODULE, AND ELECTRONIC DEVICE

(71) Applicant: KYOCERA CORPORATION, Kyoto (JP)

(72) Inventor: Hiroaki WATANABE, Yokohama-shi, Kanagawa (JP)

(21) Appl. No.: 18/874,583

(22) PCT Filed: Jun. 2, 2023
(86) PCT No.: PCT/JP2023/020660

§ 371 Date: Dec. 12, 2024

(30) Foreign Application Priority Data
Jun. 17, 2022 (JP) 2022-098421

(51) Int. Cl. H01R 12/71; H01R 13/639

(52) U.S. Cl. CPC H01R 12/716; H01R 13/639

(57) ABSTRACT

The present disclosure provides a connector 10 that is configured to be connected to a connection target 50 and that includes an insulator 20 including a first recess 27 recessed from an inner surface of a side wall 22b of an outer peripheral wall 22 and configured to be fitted to the connection target 50, and a plurality of first contacts 30 each including a contact portion 32c positioned inside the side wall 22b. Each of the first contacts 30 is formed integrally with the side wall 22b, the contact portion 32c is disposed in the first recess 27, the insulator 20 is cut out in an array direction of the plurality of first contacts 30 with respect to the contact portion 32c, and each of the first contacts 30 is elastically deformed integrally with the side wall 22b upon fitting.

### CROSS-REFERENCE TO RELATED APPLICATIONS

The present application claims priority of Japanese Patent Application No. 2022-098421 filed to Japan on Jun. 17, 2022, and an entire disclosure of this application is incorporated herein for reference.

### TECHNICAL FIELD

The present disclosure relates to a connector, a connector module, and an electronic device.

### BACKGROUND OF INVENTION

In recent years, electronic devices including wearable devices and the like have been required to have size reduction of a connector provided therein and durability enough to compensate for deterioration in strength due to the size reduction. For example, in terms of designing, a contact attached to the connector is changed in shape for the size reduction of the connector, or the contact is formed integrally with an insulator by insert molding for improvement in durability.

Patent Literature 1 discloses an electrical connector configured to excellently prevent disengagement between connectors by avoiding deterioration in locking strength between the connectors even when terminals are reduced in thickness and the connectors are reduced in height.

### CITATION LIST

### Patent Literature

Patent Literature 1: Japanese Patent No. 5444283

### SUMMARY

In an embodiment of the present disclosure, a connector is configured to be connected to a connection target. The connector includes an insulator and a plurality of first contacts. The insulator includes a side wall of an outer peripheral wall and a first recess recessed from an inner surface of the side wall. The insulator is configured to be fitted to the connection target. The plurality of first contacts each includes a contact portion positioned inside the side wall. Each of the first contacts is formed integrally with the side wall. The contact portion is disposed in the first recess. The insulator is cut out in an array direction of the plurality of first contacts with respect to the contact portion. Each of the first contacts is elastically deformed integrally with the side wall when the connector and the connection target are fitted to each other.

In an embodiment of the present disclosure, a connector module includes the connector and the connection target configured to be connected to the connector.

In an embodiment of the present disclosure, an electronic device includes the connector or the connector module.

### BRIEF DESCRIPTION OF THE DRAWINGS

FIG. 1 is an external perspective view from the top of a connector module according to an embodiment in a state where a first connector and a second connector are connected to each other.

FIG. 2 is an external perspective view from the top of a connector module according to an embodiment in a state where a first connector and a second connector are separate from each other.

FIG. 3 is an external perspective view from the top of the first connector alone illustrated in FIG. 1.

FIG. 4 is an external perspective view from the top of the first connector illustrated in FIG. 3 in an exploded state.

FIG. 5 is a sectional view taken along arrow V-V indicated in FIG. 3.

FIG. 6 is an enlarged sectional view of a portion VI surrounded with a dashed line indicated in FIG. 5.

FIG. 7 is an external perspective view from the top of the second connector alone illustrated in FIG. 1.

FIG. 8 is an external perspective view from the top of the second connector illustrated in FIG. 7 in an exploded state.

FIG. 9 is a sectional view taken along arrow IX-IX indicated in FIG. 1.

FIG. 10 is a schematic view illustrating a state of the first connector upon insert molding.

### DESCRIPTION OF EMBODIMENTS

In the electrical connector according to Patent Literature 1, a receptacle connector includes a first contact and an insulator formed integrally by insert molding. In such an electrical connector, the first contact includes a U-shaped portion attached to a side wall of the insulator by insert molding. However, both the first contact and the insulator are less likely to be elastically deformed. When a plug connector as a connection target and the receptacle connector are fitted to each other, a second contact of the plug connector and the first contact may come into contact with each other to cause abrasion between contact portions. This results in deterioration of contact reliability at each of the contacts.

According to an embodiment of the present disclosure, a connector, a connector module, and an electronic device can reduce deterioration of contact reliability at a contact even in a case where the contact and an insulator are formed integrally.

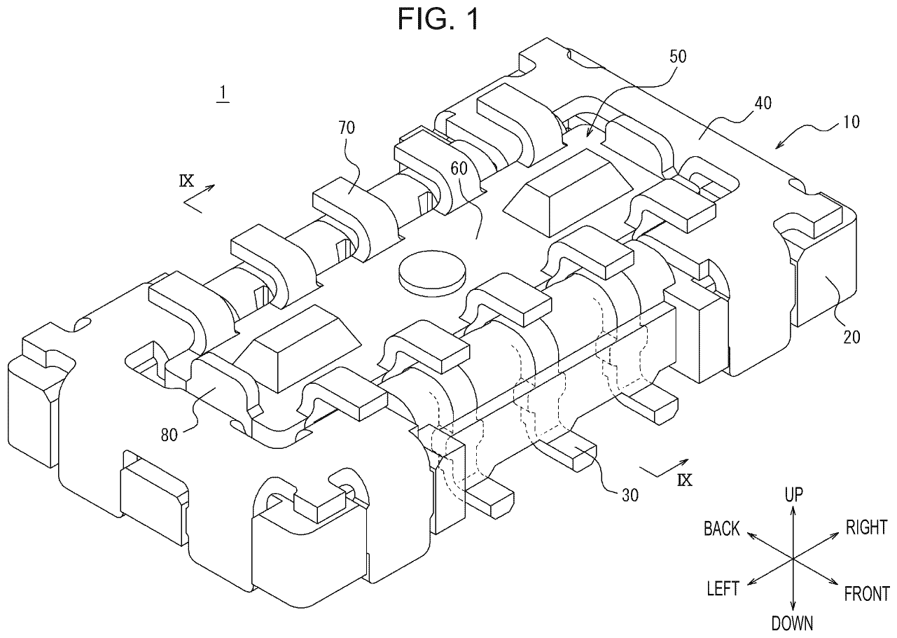

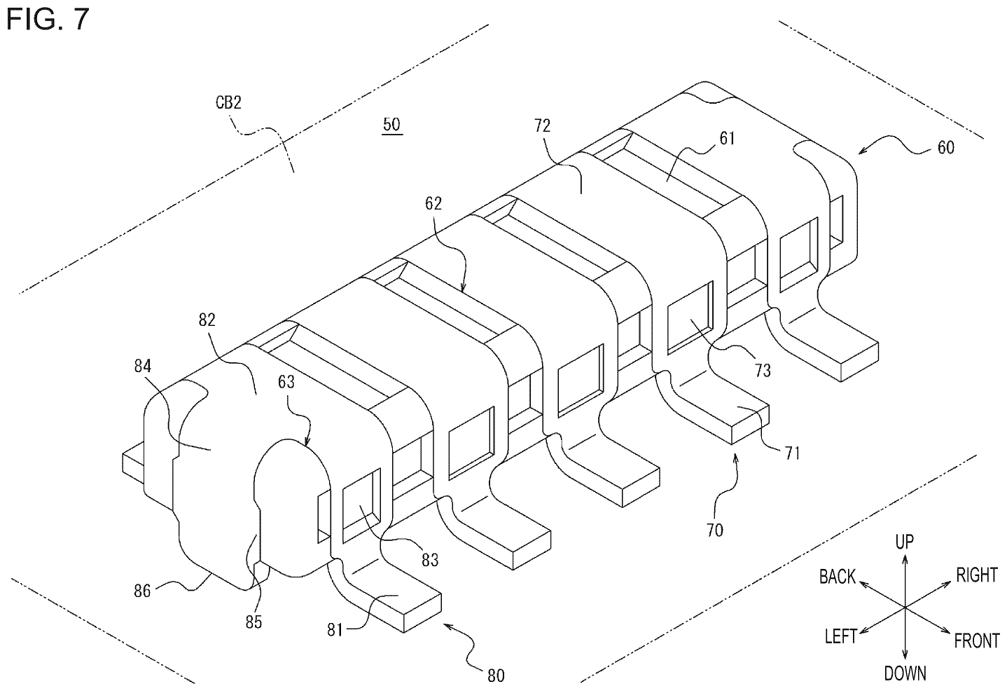

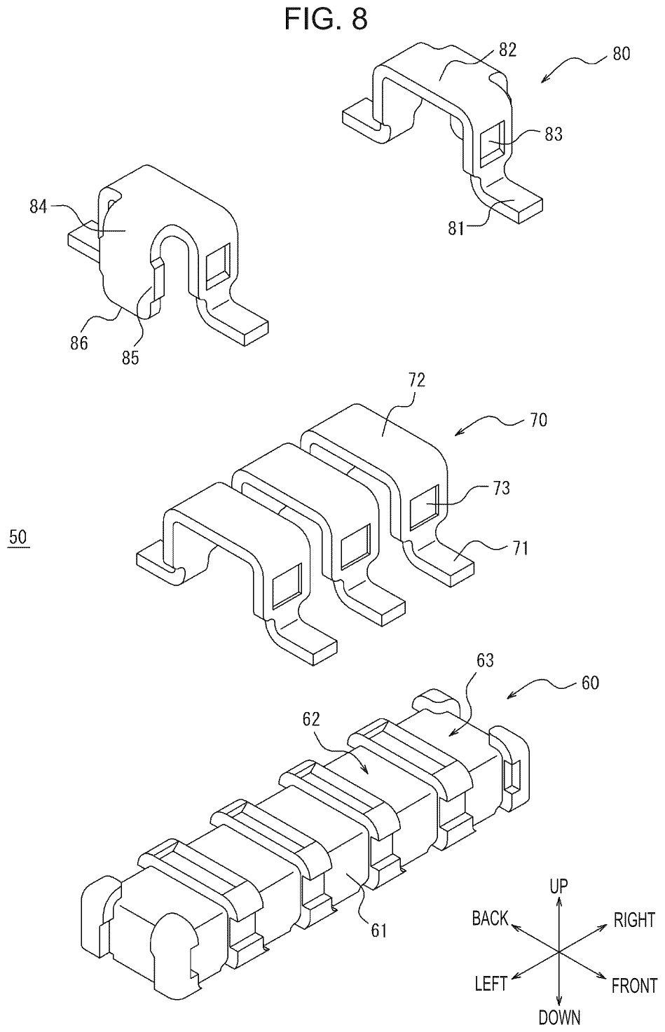

An embodiment of the present disclosure will be described in detail hereinafter with reference to the accompanying drawings. The following description refers to anteroposterior, lateral, and vertical directions which are according to directions of arrows indicated in the drawings. The directions of the respective arrows are matched among the different figures of FIGS. 1 to 6, FIG. 9, and FIG. 10. The directions of the respective arrows are matched between the different figures of FIG. 7 and FIG. 8. Some figures do not illustrate a circuit board CB1 or CB2 to be described later for simplified illustration.

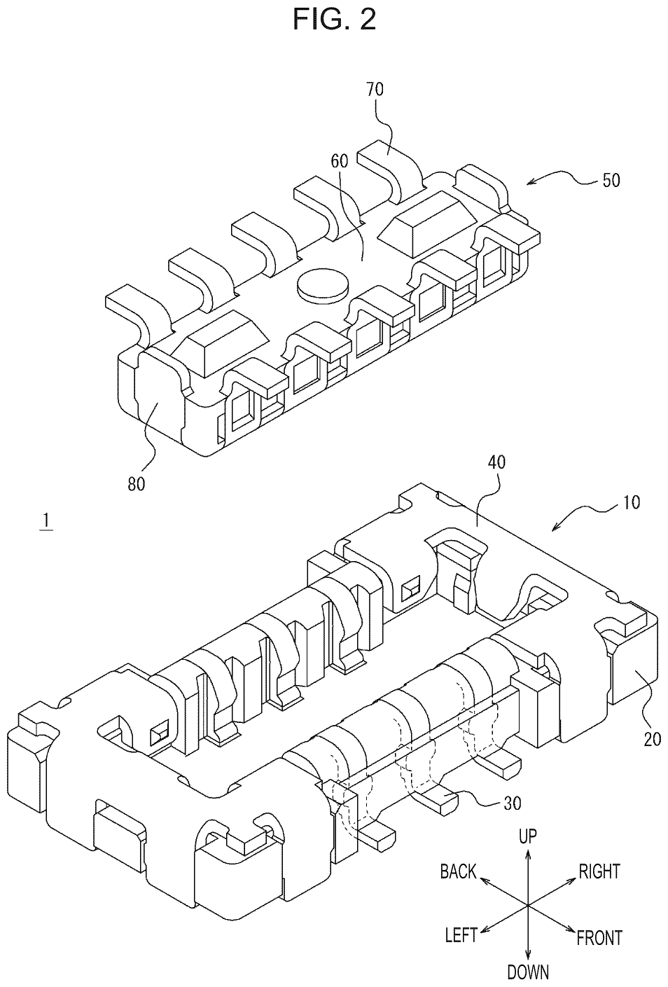

FIG. 1 is an external perspective view from the top of a connector module 1 according to an embodiment in a state where a first connector 10 and a second connector 50 are connected to each other. FIG. 2 is an external perspective view from the top of the connector module 1 according to an embodiment in the state where the first connector 10 and the second connector 50 are separate from each other.

As illustrated in FIG. 2 or the like, the connector module 1 includes the first connector 10 and the second connector 50 connectable to each other. The first connector 10 is connected to the second connector 50 as a connection target. The first connector 10 includes a first insulator 20, and a first contact 30 attached to the first insulator 20. The first connector 10 includes a first metal part 40 attached to the first insulator 20.

The second connector 50 is connectable to the first connector 10. The second connector 50 includes a second insulator 60 fitted to the first insulator 20 in a connection state where the first connector 10 and the second connector 50 are connected to each other. The second connector 50 includes a second contact 70 attached to the second insulator 60. The second contact 70 is in contact with the first contact 30 in a fitting state where the first insulator 20 and the second insulator 60 are fitted to each other. The second connector 50 includes a second metal part 80 attached to the second insulator 60. The second metal part 80 is in contact with the first metal part 40 in the fitting state. The first metal part 40 is elastically deformed in this case.

Description is hereinafter made to an exemplary case where the first connector 10 according to an embodiment is a receptacle connector. The description exemplarily assumes that the second connector 50 is a plug connector. The description assumes that the receptacle connector corresponds to the first connector 10 in which the first contact 30 and the first insulator 20 are elastically deformed in the fitting state where the first insulator 20 and the second insulator 60 are fitted to each other. The description assumes that a plug connector corresponds to the second connector 50 in which the second contact 70 is not elastically deformed in the fitting state. The first connector 10 and the second connector 50 are not limited to these in terms of types. For example, the first connector 10 may serve as a plug connector. The second connector 50 may serve as a receptacle connector.

The connection target to be connected to first connector 10 is not limited to the second connector 50. The connection target may be any appropriate target other than the plug connector and the receptacle connector. For example, the connection target may be a card edge of a flexible printed circuit board (FPC), a flexible flat cable, a rigid substrate, or any appropriate circuit board.

The following description assumes that the first connector 10 and the second connector 50 are mounted on the circuit boards CB1 and CB2, respectively. In the connection state where the first connector 10 and the second connector 50 are connected to each other, the first connector 10 and the second connector 50 electrically connect the circuit board CB1 and the circuit board CB2. Each of the circuit boards CB1 and CB2 may be a rigid substrate or any other appropriate circuit board. For example, at least one of the circuit board CB1 or CB2 may be an FPC.

The following description assumes that the first connector 10 and the second connector 50 are connected to each other at a right angle to the circuit boards CB1 and CB2. The first connector 10 and the second connector 50 are connected to each other exemplarily in the vertical direction. A connection method is not limited to the above. The first connector 10 and the second connector 50 may alternatively be connected to each other parallelly with respect to the circuit boards CB1 and CB2. The first connector 10 and the second connector 50 may still alternatively be connected to each other such that one of these connectors is mounted at a right angle to a corresponding one of the circuit boards and the other is mounted parallelly to the other circuit board.

The present disclosure refers to a “fitting direction” exemplarily corresponding to the vertical direction. A “longitudinal direction” exemplarily corresponds to a lateral direction. An “array direction of a plurality of first contacts 30” exemplarily corresponds to the lateral direction. A “short direction” exemplarily corresponds to an anteroposterior direction. A “fitting side” exemplarily corresponds to a lower side. An “extracting side” exemplarily corresponds to an upper side. A “side of the circuit board CB1” exemplarily corresponds to the lower side. An “opposite side of the circuit board CB1” exemplarily corresponds to the upper side. An “inner side” corresponds to a direction toward a center of the first connector 10. For example, the inner side in the anteroposterior direction corresponds to a direction toward the center of the first connector 10 in the anteroposterior direction. The inner side is not limited to this case, does not completely correspond to the direction toward the center in the anteroposterior direction, and may correspond to a direction toward the center in a slightly oblique direction. The same or a similar applies to different directions. An “outer side” is opposite to the inner side.

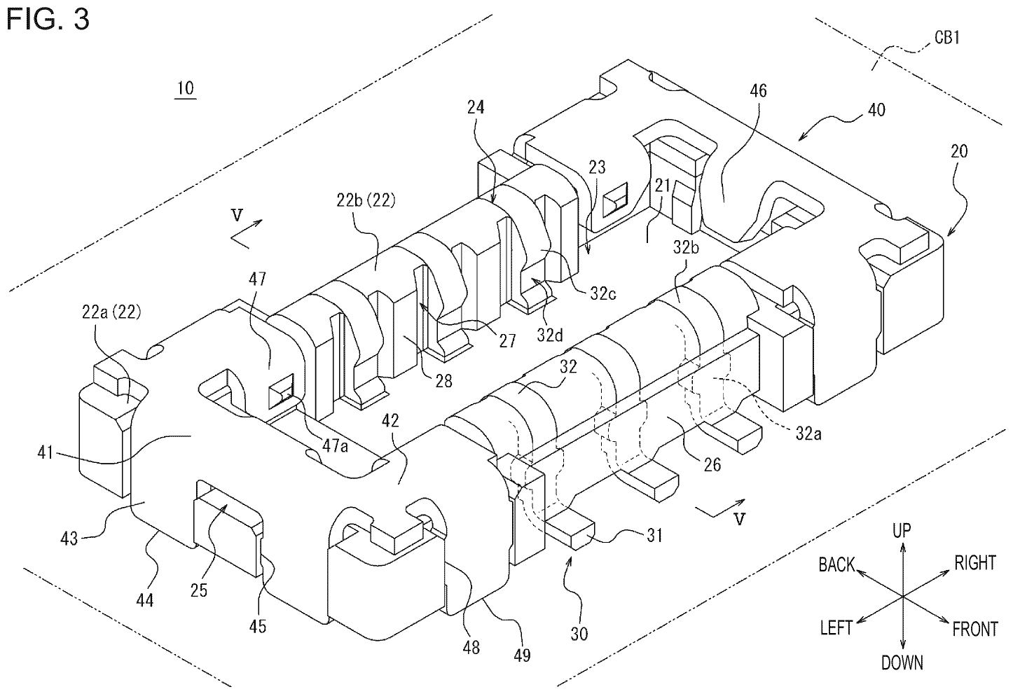

FIG. 3 is an external perspective view from the top of the first connector 10 alone illustrated in FIG. 1. The first connector 10 is exemplarily obtained by integrally forming the first contact 30 and the first insulator 20 by insert molding and press fitting the first metal part 40 to the first insulator 20.

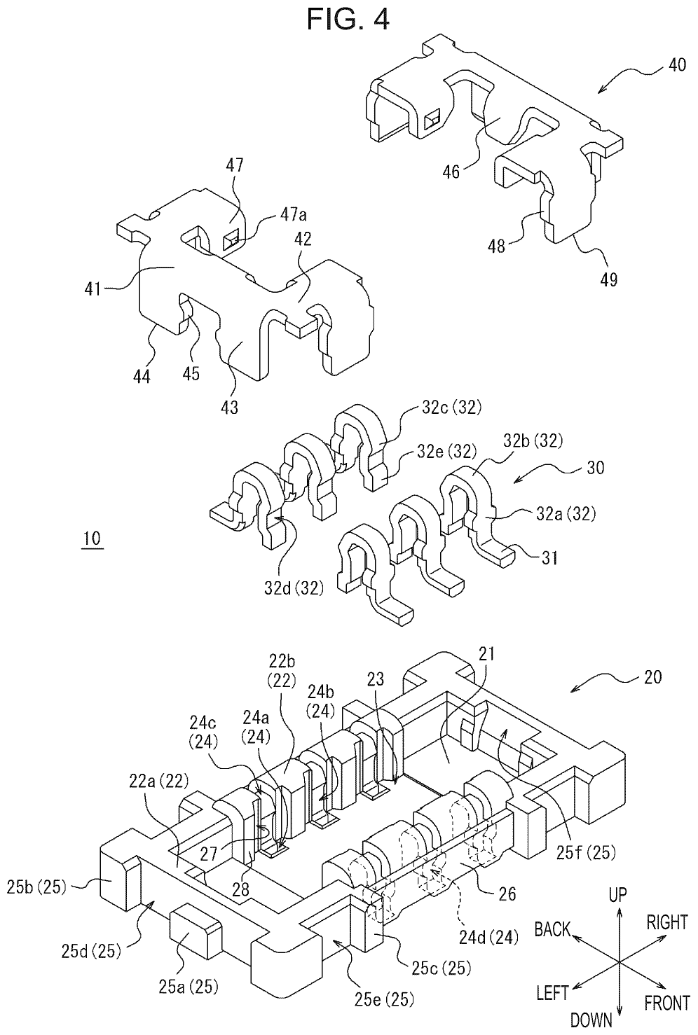

FIG. 4 is an external perspective view from the top of the first connector 10 illustrated in FIG. 3 in an exploded state. In practice, the first contact 30 and the first insulator 20 are formed integrally by insert molding. FIG. 4 individually illustrates the first insulator 20 and the first contact 30 virtually separated from each other for easier comprehension. Accordingly, the first insulator 20 includes constituent portions named for convenience, such as a through portion 24a, a first recess 24b, a second recess 24c, and a third recess 24d, which will be described later. However, note that the first contact 30 and the first insulator 20 are formed integrally by insert molding in practice at these constituent portions which are thus not original constituent portions of the first insulator 20.

The first insulator 20 constituting the first connector 10 is made of a synthetic resin material having insulation characteristics and heat resistance characteristics. The first insulator 20 has a plate shape extending laterally. The first insulator 20 includes a bottom plate 21 constituting a lower portion. The first insulator 20 includes an outer peripheral wall 22 having a ring shape and projecting upward from an entire peripheral edge of an upper surface of the bottom plate 21. The outer peripheral wall 22 includes a pair of short walls 22a extending in the anteroposterior direction and a pair of long walls 22b extending in the lateral direction. The first insulator 20 includes a fitting recess 23 constituted by a space formed by the bottom plate 21 and the outer peripheral wall 22.

The first insulator 20 includes a first contact retention groove 24 provided from an anteroposterior inner surface of a recess 27 to be described later in each of the long walls 22b of the outer peripheral wall 22 to an outer surface opposite to the inner surface via an upper surface. There is provided a plurality of first contact retention grooves 24 correspondingly to the number of the first contacts 30. The plurality of first contact retention grooves 24 is arrayed along to the array direction of the first contacts 30. The first contact retention grooves 24 integrally retain the first contacts 30. Each of the first contact retention grooves 24 includes a portion that is in contact with an inner surface of the first contact 30 and that is accordingly identical in surface shape to the inner surface of the first contact 30.

The first contact retention groove 24 includes the through portion 24a penetrating a portion of the bottom plate 21 adjacent to the inner surface of the recess 27 in the long wall 22b toward the circuit board CB1. The first contact retention groove 24 includes the first recess 24b recessed and extending linearly upward from the through portion 24a along the inner surface of the recess 27 in the long wall 22b. The first contact retention groove 24 includes the second recess 24c formed into an inverted U shape adjacent to an upper surface of the long wall 22b and recessed from the inner surface of the recess 27 to an outer surface of the long wall 22b via the upper surface of the long wall 22b. The second recess 24c is formed from an upper end portion of the first recess 24b to be folded back. The first contact retention groove 24 includes the third recess 24d recessed and extending linearly downward from the second recess 24c along the outer surface of the long wall 22b.

The first insulator 20 includes a first metal part attachment portion 25 provided on lateral end portions of the long walls 22b and each of the short walls 22a. The first metal part 40 is attached to the first metal part attachment portion 25.

The first metal part attachment portion 25 includes a first wall portion 25a provided below an anteroposterior center of the short wall 22a and projecting laterally outward. The first metal part attachment portion 25 includes a second wall portion 25b provided at a corner of the first insulator 20 to extend from the short wall 22a to the long wall 22b. The second wall portion 25b projects outward in the anteroposterior and lateral directions. The first metal part attachment portion 25 includes a third wall portion 25c laterally spaced apart from the second wall portion 25b and provided on the long wall 22b. The first wall portion 25a, the second wall portion 25b, and the third wall portion 25c form an outermost rectangular shape in the anteroposterior and lateral directions of the first insulator 20.

The first metal part attachment portion 25 includes a first attachment groove 25d provided between the first wall portion 25a and the second wall portion 25b. The first metal part attachment portion 25 includes a second attachment groove 25e provided between the second wall portion 25b and the third wall portion 25c. The first metal part attachment portion 25 includes a third attachment groove 25f recessed at an anteroposterior center of an inner surface of the short wall 22a.

The first insulator 20 includes an outer wall 26 extending from the third wall portion 25c of the first metal part attachment portion 25 positioned on a first side in the lateral direction to the third wall portion 25c of the first metal part attachment portion 25 positioned on a second side to couple the two third wall portions 25c. The outer wall 26 extends along the outer surface of the long wall 22b of the outer peripheral wall 22 in a region provided with the first contacts 30. The outer wall 26 is provided at a longitudinal center of the first insulator 20 correspondingly to the region positioned at a center of the long wall 22b.

The first insulator 20 includes the recess 27 recessed from an inner surface 28 of the long wall 22b of the outer peripheral wall 22. The first contact retention groove 24 is recessed at a lateral center in the recess 27. The first insulator 20 includes the inner surface 28 of the outer peripheral wall 22 adjacent to the recess 27. The inner surface 28 is provided to be laterally adjacent to the recess 27. The recess 27 and the inner surface 28 are provided alternately from a first side to a second side in the lateral direction of the long wall 22b.

The first contact retention groove 24 and the recess 27 are provided in a first portion where the first insulator 20 is smaller in anteroposterior width than the outer peripheral wall 22 on the inner surface 28. The inner surface 28 is provided in a second portion where the first insulator 20 is larger in anteroposterior width than the first portion. A narrowed portion as the first portion and a widened portion as the second portion are provided alternately from the first side to the second side in the lateral direction of the long wall 22b.

The first contact 30 is processed by forming into the shape illustrated in FIG. 4 with use of a progressive die (by stamping) a thin plate having spring elasticity and made of a copper alloy containing phosphor bronze, beryllium copper, titanium copper, or the like, or a Corson copper alloy. A method of processing the first contact 30 includes punching and then bending in a plate thickness direction. The first contact 30 includes a surface provided with a nickel-plated foundation and then plated with gold, tin, or the like. Plating with gold, tin, or the like may be applied to the entire surface of the first contact 30 or may be applied only to a surface of a contact portion 32c to be described later.

The first contact 30 includes a mount portion 31 extending outward to have an L shape. The mount portion 31 is positioned at a first end of the first contact 30. The first contact 30 includes an attachment portion 32 formed into an inverted U shape upward from an upper end portion of the mount portion 31. The attachment portion 32 is formed from the upper end portion of the mount portion 31 to be folded back.

The first contact 30 includes a wide portion 32a provided in a portion positioned anteroposteriorly outside in the attachment portion 32. The first contact 30 includes a curved portion 32b extending into an inverted U shape upward from the wide portion 32a in the attachment portion 32. The first contact 30 includes the contact portion 32c configured to include an anteroposterior inner surface anteroposteriorly inside the curved portion 32b. The first contact 30 includes a recess 32d provided right under the contact portion 32c and continuously from the contact portion 32c in the attachment portion 32. The first contact 30 includes a free end 32e provided right under the recess 32d and continuously from the recess 32d in the attachment portion 32. The free end 32e corresponds to a second end opposite to the first end of the first contact 30. The free end 32e is positioned opposite to the mount portion 31 in the attachment portion 32.

In the first contact 30, the contact portion 32c and the free end 32e are positioned on an identical side in the anteroposterior direction with respect to the long wall 22b. In the attachment portion 32, the contact portion 32c and the free end 32e are positioned on the identical side in the anteroposterior direction with respect to the long wall 22b. The contact portion 32c is provided in a portion positioned anteroposteriorly inside the free end 32e provided in the first contact 30.

The recess 32d is positioned between the contact portion 32c and the free end 32e, and is formed to be recessed from the contact portion 32c and the free end 32e. The recess 32d is formed to be recessed anteroposteriorly outward in the portion positioned anteroposteriorly inside the contact portion 32c and the free end 32e provided in the first contact 30. The anteroposterior direction corresponds to a direction perpendicular to the fitting direction and the array direction of the plurality of first contacts 30.

The first contact 30 is formed to project anteroposteriorly inward in the contact portion 32c and be recessed anteroposteriorly outward by one step in the recess 32d. The first contact 30 is formed such that an anteroposterior inner surface of the free end 32e is positioned substantially identically in the anteroposterior direction to a projecting tip of the contact portion 32c.

The first metal part 40 is processed by forming into the shape illustrated in FIG. 4 with use of a progressive die (by stamping) a thin plate made of any appropriate metal material. A method of processing the first metal part 40 includes punching and then bending in a plate thickness direction. The first metal part 40 is press fitted to the first metal part attachment portion 25 of the first insulator 20 and is disposed at each lateral side of the first insulator 20.

The first metal part 40 includes a first base 41 extending in the anteroposterior direction. The first metal part 40 includes a second base 42 extending laterally inward from each anteroposterior end portion of the first base 41. The first metal part 40 includes a projecting piece 43 extending linearly downward at each of a front portion and a rear portion of the first base 41. A recess is formed by facing edges of the pair of projecting pieces 43 anteroposteriorly spaced apart from each other and a lower edge of the first base 41.

The first metal part 40 includes a first mount portion 44 positioned at a lower end of each of the projecting pieces 43. The first metal part 40 includes a first lock portion 45 including a portion formed to be anteroposteriorly wider than the remaining portion of the projecting piece 43. The first metal part 40 includes a contact portion 46 extending laterally inward from an anteroposterior center of the first base 41. The contact portion 46 extends obliquely downward in the lateral direction from the first base 41 and has spring elasticity.

The first metal part 40 includes a projecting piece 47 formed into an inverted U shape at a laterally inner end portion of the second base 42. The first metal part 40 includes an engaging portion 47a provided in a portion extending anteroposteriorly inward in the projecting piece 47. The engaging portion 47a is formed as a protrusion.

The first metal part 40 includes a second lock portion 48 extending downward continuously from a lower end portion of a portion extending anteroposteriorly outward in the projecting piece 47. The second lock portion 48 is formed laterally wider than the portion extending anteroposteriorly outward in the projecting piece 47. The second lock portion 48 symmetrically projects to both lateral sides from the portion. The first metal part 40 includes a second mount portion 49 extending linearly downward from a lower end portion of the second lock portion 48. The second mount portion 49 is formed to be substantially identical in lateral width to the portion extending anteroposteriorly outward in the projecting piece 47.

As illustrated in FIGS. 3 and 4, the first contact 30 is disposed in the longitudinal direction of the first connector 10. The first contact 30 is disposed at a lateral center of the first insulator 20.

The first contact 30 is integrally retained to the first contact retention groove 24 that is integrated by insert molding with an entire portion excluding the mount portion 31. More specifically, the attachment portion 32 of the first contact 30 is integrally retained to the first contact retention groove 24. The first contact 30 is formed integrally with the outer peripheral wall 22.

The first contact 30 is formed integrally with the first contact retention groove 24 such that the third recess 24d and the second recess 24c are flush along the long wall 22b. The first contact 30 is formed integrally with the first contact retention groove 24 such that the contact portion 32c and the recess 32d project inward by one step from the outer peripheral wall 22 than an anteroposterior side surface of the recess 27 of the first insulator 20 in the first recess 24b.

The contact portion 32c of the first contact 30 is disposed in the recess 27. More specifically, the contact portion 32c is positioned at the lateral center in the recess 27. On each side of the contact portion 32c in the array direction of the plurality of first contacts 30, the first insulator 20 is cut out due to provision of the recess 27. The inner surface 28, part of the recess 27, the contact portion 32c, different part of the recess 27, and the inner surface 28 are provided in the mentioned order from the first side to the second side in the lateral direction of the long wall 22b. The recess 27, the contact portion 32c, the recess 32d, and the free end 32e are overlapped with one another in the anteroposterior direction.

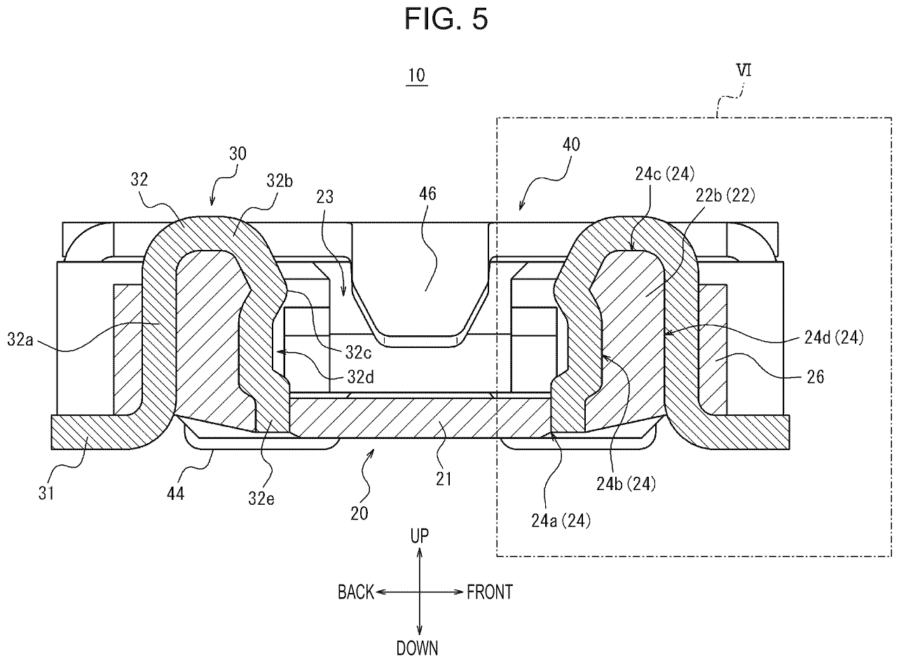

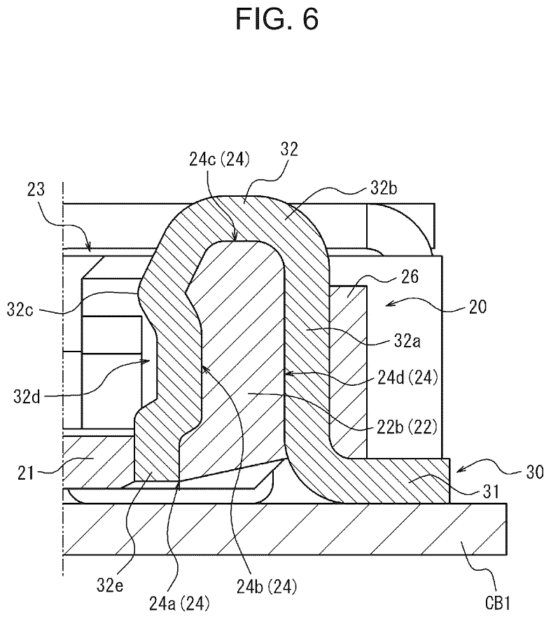

FIG. 5 is a sectional view taken along arrow V-V indicated in FIG. 3. FIG. 6 is an enlarged sectional view of a portion VI surrounded with a dashed line indicated in FIG. 5.

The wide portion 32a of the attachment portion 32 is formed integrally with the third recess 24d of the first contact retention groove 24. The curved portion 32b of the attachment portion 32 is formed integrally with the second recess 24c of the first contact retention groove 24. The contact portion 32c and the recess 32d of the attachment portion 32 are formed integrally with the first recess 24b of the first contact retention groove 24. The free end 32e of the attachment portion 32 is formed integrally with the through portion 24a of the first contact retention groove 24.

When the first contact 30 is retained to the first contact retention groove 24 of the first insulator 20, the mount portion 31 of the first contact 30 is formed into an L shape and extends outward from the outer surface of the outer peripheral wall 22. More specifically, the mount portion 31 includes a tip positioned anteroposteriorly outside the outer wall 26. The attachment portion 32 of the first contact 30 extends into an inverted U shape from the mount portion 31 oppositely from the circuit board CB1 and is attached to the outer peripheral wall 22 from the outer surface of the outer peripheral wall 22 to the inner surface of the recess 27 of the outer peripheral wall 22.

In this case, the contact portion 32c of the first contact 30 is positioned inside the outer peripheral wall 22. The contact portion 32c is positioned anteroposteriorly inside the long wall 22b. A pair of contact portions 32c of a pair of first contacts 30 retained respectively at identical lateral positions of the pair of long walls 22b faces each other in the anteroposterior direction. The pair of contact portions 32c interposes only the space serving as the fitting recess 23 and does not interpose any constituent portion relevant to the first contact 30.

The contact portion 32c is positioned inside the outer peripheral wall 22 rather than the inner surface 28 of the first insulator 20. The contact portion 32c is disposed anteroposteriorly inside the inner surface 28. Constituent portions provided at identical lateral positions of the pair of long walls 22b have an anteroposterior interval narrowed at the pair of contact portions 32c of the pair of first contacts 30 retained at the identical lateral positions of the pair of long walls 22b.

The free end 32e of the first contact 30 is exposed from a bottom surface facing the circuit board CB1 toward the circuit board CB1 in the first insulator 20. In this case, the free end 32e is flush with a lower surface of the bottom plate 21 of the first insulator 20 in the lateral direction perpendicular to sheets of FIGS. 5 and 6. The free end 32e is positioned opposite to circuit board CB1 rather than the mount portion 31. The free end 32e is vertically spaced apart from the circuit board CB1. The free end 32e and the circuit board CB1 interpose a space.

As illustrated in FIGS. 3 and 4, the first metal part 40 is press fitted from above the first insulator 20. The first metal part 40 is attached to the outer peripheral wall 22 such that the first wall portion 25a is interposed by the recess formed by the facing edges of the pair of projecting pieces 43 anteroposteriorly spaced apart from each other and the lower edge of the first base 41.

The first lock portion 45 is locked to the first wall portion 25a of the first metal part attachment portion 25 at a position laterally outside the short wall 22a. The pair of projecting pieces 43 anteroposteriorly spaced apart from each other and the first lock portion 45 are attached to the first attachment groove 25d. In the same or a similar manner, the second lock portion 48 is locked to the second wall portion 25b and the third wall portion 25c of the first metal part attachment portion 25 at a position anteroposteriorly outside the long wall 22b. The second lock portion 48 is attached to the second attachment groove 25e. Accordingly, the first metal part 40 is retained to the first metal part attachment portion 25.

The first metal part 40 retained to the first metal part attachment portion 25 of the first insulator 20 covers the entire short wall 22a and the lateral end portions of the long walls 22b. In this case, the contact portion 46 is disposed to be elastically deformable in the lateral direction in the third attachment groove 25f of the first insulator 20.

The first mount portion 44 is disposed along a lateral outer surface of the short wall 22a. As illustrated also in FIG. 5, the first mount portion 44 extends downward from a lower end portion of the short wall 22a. As illustrated in FIGS. 3 and 4, the first mount portion 44 is disposed on each side of the first wall portion 25a of the first insulator 20 in the short direction of the first connector 10. The pair of first mount portions 44 is positioned to interpose the first wall portion 25a from both anteroposterior sides. For example, the pair of first mount portions 44 is positioned to be anteroposteriorly symmetrical with respect to the first wall portion 25a.

The second mount portion 49 is disposed along an anteroposterior outer surface of the long wall 22b. The second mount portion 49 extends downward from a lower end portion of the long wall 22b. The second mount portion 49 is disposed on each side in the short direction of the first connector 10. The pair of second mount portions 49 is positioned to interpose the fitting recess 23 from both anteroposterior sides. For example, the pair of second mount portions 49 is positioned to be anteroposteriorly symmetrical with respect to the fitting recess 23. The pair of second mount portions 49 is disposed at substantially identical lateral positions.

In the first connector 10 structured as described above, the mount portion 31 of the first contact 30 is soldered to a circuit pattern provided on a mount surface of the circuit board CB1. The first mount portion 44 and the second mount portion 49 of the first metal part 40 are soldered to the pattern provided on the mount surface. In this manner, the first connector 10 is mounted to the circuit board CB1. The mount surface of the circuit board CB1 is provided with an electronic component such as a CPU (central processing unit), a controller, or a memory other than the first connector 10.

A configuration of the second connector 50 will be described with reference mainly to FIGS. 7 and 8.

FIG. 7 is an external perspective view from the top of the second connector 50 alone illustrated in FIG. 1. The second connector 50 is exemplarily obtained by integrally forming the second contact 70, the second metal part 80, and the second insulator 60 by insert molding.

FIG. 8 is an external perspective view from the top of the second connector 50 illustrated in FIG. 7 in an exploded state. In practice, the second contact 70, the second metal part 80, and the second insulator 60 are formed integrally by insert molding. However, FIG. 8 individually illustrates the second insulator 60, the second contact 70, and the second metal part 80 virtually separated from one another for easier comprehension.

The second insulator 60 is a plate-shaped member extending in the lateral direction and obtained by injection molding a synthetic resin material having insulation characteristics and heat resistance characteristics. The second insulator 60 includes ta body 61 formed into a rectangular parallelepiped shape. The body 61 is provided as a fitting portion.

The second insulator 60 includes a second contact retention groove 62 provided on both anteroposterior side surfaces and an upper surface of the body 61. The second contact 70 is attached to the second contact retention groove 62. The second insulator 60 includes a second metal part retention groove 63 provided at each lateral end of the body 61. The second metal part retention groove 63 is provided on both the anteroposterior side surfaces, a lateral side surface, and the upper surface of the body 61. The second metal part 80 is attached to the second metal part retention groove 63.

The second contact 70 is processed by forming into the shape illustrated in the figures with use of a progressive die (by stamping) a thin plate made of a copper alloy containing phosphor bronze, beryllium copper, titanium copper, or the like, or a Corson copper alloy. The second contact 70 includes a surface provided with a nickel-plated foundation and then plated with gold, tin, or the like.

The second contact 70 includes a mount portion 71 extending into an L shape outward in the anteroposterior direction. The second contact 70 includes a base 72 extending into a U shape upward from one mount portion 71 and connected to an other mount portion 71. The second contact 70 includes a contact portion 73 recessed in an anteroposterior outer surface of the base 72. The contact portion 73 is formed as a recess.

The second metal part 80 is processed by forming into the shape illustrated in the figures with use of a progressive die (by stamping) a thin plate made of any appropriate metal material. A method of processing the second metal part 80 includes punching and then bending in a plate thickness direction.

The second metal part 80 includes a first mount portion 81 extending into an L shape outward in the anteroposterior direction. The second metal part 80 includes a base 82 extending into a U shape upward from one first mount portion 81 and connected to an other first mount portion 81. The second metal part 80 includes an engaging portion 83 recessed in an anteroposterior outer surface of the base 82. The engaging portion 83 is formed as a recess.

The second metal part 80 includes an extending portion 84 extending into an L shape laterally outward from a lateral outer end portion of the base 82. The second metal part 80 includes a wide portion 85 formed to be anteroposteriorly wide in the extending portion 84. The second metal part 80 includes a second mount portion 86 positioned at a lower end of the extending portion 84.

The second contact 70 is formed integrally with the second contact retention groove 62 of the second insulator 60 by insert molding. In this case, the substantially entirety of the base 72 of the second contact 70 is formed integrally with the second contact retention groove 62. A pair of contact portions 73 is disposed respectively along both anteroposterior outer surfaces of the body 61. The mount portion 71 extends anteroposteriorly outward from the anteroposterior outer surface of the body 61.

The second metal part 80 is formed integrally with the second metal part retention groove 63 of the second insulator 60 by insert molding. In this case, the substantially entirety of the base 82 and the extending portion 84 of the second metal part 80 is formed integrally with the second metal part retention groove 63. A pair of engaging portions 83 is disposed respectively along both the anteroposterior outer surfaces of the body 61. The first mount portion 81 extends anteroposteriorly outward from the anteroposterior outer surface of the body 61. The second mount portion 86 is disposed along a lateral outer surface of the body 61.

In the second connector 50 structured as described above, the mount portion 71 of the second contact 70 is soldered to a circuit pattern provided on a mount surface of the circuit board CB2. The first mount portion 81 and the second mount portion 86 of the second metal part 80 are soldered to the pattern provided on the mount surface. In this manner, the second connector 50 is mounted to the circuit board CB2. The mount surface of the circuit board CB2 is provided with an electronic component such as a communication module other than the second connector 50.

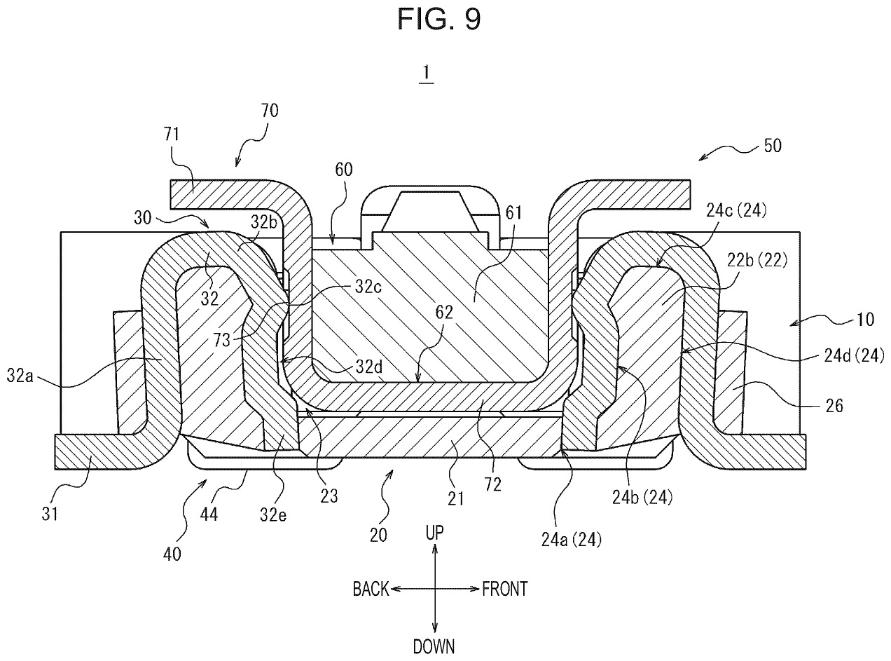

With reference to FIG. 9, description is made mainly to a configuration of the connector module 1 in a fitting state where the first connector 10 and the second connector 50 as a connection target are connected to each other and the first insulator 20 and the second connector 50 as a connection target are fitted. FIG. 9 is a sectional view taken along arrow IX-IX indicated in FIG. 1.

In an exemplary state where the second connector 50 illustrated in FIG. 7 is vertically inverted, the first connector 10 and the second connector 50 are made to vertically face each other while being substantially matched in anteroposterior and lateral positions. The second connector 50 is shifted downward. Accordingly, first connector 10 and the second connector 50 are connected to each other to achieve a connection state of the connector module 1. In this case, the fitting recess 23 of the first insulator 20 and the body 61 of the second insulator 60 are fitted to each other.

When the first connector 10 and the second connector 50 are fitted to each other, the contact portion 32c of the first contact 30 and the contact portion 73 of the second contact 70 come into contact with each other and the attachment portion 32 having spring elasticity is elastically deformed anteroposteriorly outward. The first contact 30 and the second contact 70 come into contact with each other at two points on both front and back sides by sets of the contact portions 32c and the contact portions 73.

When the first connector 10 and the second connector 50 are fitted to each other, the pair of first contacts 30 including the contact portions 32c disposed to face each other interposes one second contact 70 of the second connector 50. The one second contact 70 is in contact with both the pair of the first contacts 30. More specifically, the substantially entirety of the base 72 of the one second contact 70 is positioned between the pair of first contacts 30. The base 72 of the one second contact 70 is in contact with both the pair of the first contacts 30.

In this case, the first contact 30 is elastically deformed integrally with the outer peripheral wall 22 of the first insulator 20 when the first connector 10 and the second connector 50 are fitted to each other. More specifically, the attachment portion 32 of the first contact 30 is elastically deformed integrally with the long wall 22b when the first connector 10 and the second connector 50 are fitted to each other. The attachment portion 32 and the long wall 22b kept in a fitting state keep postures while being obliquely inclined outward in the anteroposterior direction from below to above.

The first metal part 40 is in contact with the second metal part 80 in the fitting state where the first connector 10 and the second connector 50 are fitted to each other. In the fitting state, the contact portion 46 of the first metal part 40 and the extending portion 84 of the second metal part 80 are in contact with each other. In this case, the contact portion 46 having spring elasticity is elastically deformed outward in the lateral direction in the third attachment groove 25f of the first insulator 20. Furthermore, the engaging portion 47a of the first metal part 40 and the engaging portion 83 of the second metal part 80 are engaged with each other in the fitting state.

According to an embodiment, the first connector 10 and the connector module 1 described above can reduce deterioration of contact reliability at the first contact 30 even in the case where the first contact 30 and the first insulator 20 are formed integrally. For example, the first connector 10 is formed integrally with the outer peripheral wall 22 in the state where the contact portion 32c is disposed in the recess 27 of the first insulator 20 and the first insulator 20 is cut out on each of the sides of the contact portion 32c. The first insulator 20 is thus formed to be narrow around the first contact 30. This facilitates integral elastic deformation of the first contact 30 and the outer peripheral wall 22 when the first connector 10 and the second connector 50 are fitted to each other.

In comparison to a related art in which an insulator and a contact are less likely to be elastically deformed when the second connector 50 as a connection target is fitted to the first connector 10, this can eventually reduce application of an excessive load to these constituent portions. This reduces damage to the first insulator 20 and the first contact 30. The first connector 10 can reduce damage such as abrasion of the first contact 30 due to contact between the first contact 30 and the second contact 70 or the like.

Furthermore, when the first contact 30 and the first insulator 20 are formed integrally by insert molding, a die part is disposed at a cutout portion in the recess 27 positioned on each lateral side of the contact portion 32c. Accordingly, a resin to form the first insulator 20 is less likely to enter an exposed surface of the contact portion 32c of the first contact 30.

The first connector 10 synergistically exhibits the above effects to reduce deterioration of contact reliability at the first contact 30.

The first contact 30 and the first insulator 20 are formed integrally to improve strength of the first connector 10 and the connector module 1 even in a case where these are reduced in size.

The first contact 30 includes the mount portion 31 positioned at the first end and the free end 32e as the second end opposite to the first end, and the contact portion 32c and the free end 32e are positioned on the identical side in the anteroposterior direction with respect to the long wall 22b in the first contact 30. This increases a distance between the mount portion 31 and the contact portion 32c. This increases a distance between a portion of the first contact 30 fixed to the circuit board CB1 and a portion to receive external force due to contact with the second contact 70. The first contact 30 is thus more likely to be elastically deformed when the first connector 10 and the second connector 50 are fitted to each other.

In comparison to the related art in which an insulator and a contact are less likely to be elastically deformed when the second connector 50 as a connection target is fitted to the first connector 10, this can eventually reduce application of an excessive load to these constituent portions. This reduces damage to the first insulator 20 and the first contact 30. The first connector 10 can reduce damage such as abrasion of the first contact 30 due to contact between the first contact 30 and the second contact 70 or the like. The first connector 10 can thus reduce deterioration of contact reliability at the first contact 30.

The first contact 30 includes the mount portion 31 formed into an L shape and extending outward from the outer surface of the outer peripheral wall 22. The first contact 30 includes the attachment portion 32 extending into an inverted U shape from the mount portion 31 oppositely from the circuit board CB1 and attached to the outer peripheral wall 22 from the outer surface of the outer peripheral wall 22 to the inner surface of the recess 27. The first contact 30 includes the free end 32e positioned opposite to the mount portion 31 in the attachment portion 32, and the contact portion 32c positioned on the identical side of the free end 32e in the anteroposterior direction with respect to the long wall 22b in the attachment portion 32. The first contact 30 is formed into such a shape to increase the distance between the mount portion 31 and the contact portion 32c. Accordingly, the first connector 10 exhibits effects same or similar to the above.

The free end 32e is exposed from the bottom surface facing the circuit board CB1 toward the circuit board CB1 in the first insulator 20. When the first contact 30 and the first insulator 20 are formed integrally by insert molding, the die part can thus press the free end 32e. This can reduce swinging of the free end 32e of the first contact 30 when the resin to form the first insulator 20 flows into a die. The first contact 30 is thus stably formed integrally with the first insulator 20 upon insert molding.

Furthermore, the free end 32e of the first contact 30 is formed integrally with the through portion 24a of the first contact retention groove 24. The first connector 10 can thus be reduced in anteroposterior size in comparison to a conventional contact exemplarily including an elastic contact piece that extends inward in the anteroposterior direction and includes a free end positioned inside an outer peripheral wall.

When the free end 32e is positioned opposite to the circuit board CB1 rather than the mount portion 31, the free end 32e and the circuit board CB1 interpose a space. This can reduce damage to the circuit board CB1 due to contact between the free end 32e and the circuit board CB1.

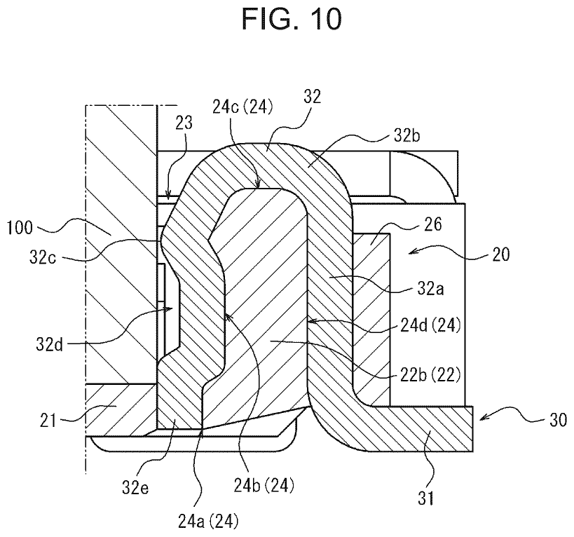

FIG. 10 is a schematic view illustrating a state of the first connector 10 upon insert molding. FIG. 10 corresponds to the enlarged sectional view in FIG. 6.

The first contact 30 includes the recess 32d recessed from the contact portion 32c and the free end 32e. When the first contact 30 and the first insulator 20 are formed integrally by insert molding, the contact portion 32c and the free end 32e can be surrounded with a die 100 in three directions. For example, the die 100 can surround the contact portion 32c and the free end 32e from inside in the anteroposterior direction and both sides in the lateral direction.

When the resin to form the first insulator 20 flows into the die 100 upon insert molding, the resin is thus less likely to enter the exposed surface of the contact portion 32c of the first contact 30. If the resin is provided at the contact portion 32c of the first contact 30, the first contact 30 is deteriorated in contact reliability. The first connector 10 can reduce deterioration of contact reliability at the first contact 30 thus configured.

The first insulator 20 includes the outer wall 26 extending along the outer surface of the outer peripheral wall 22 in the region provided with the first contacts 30. This reduces soldering flux creeping-up to the contact portion 32c even when the first connector 10 is reduced in size. Accordingly, the first connector 10 can reduce soldering formation to the contact portion 32c and can reduce deterioration of contact reliability at the first contact 30.

Effects relevant to such soldering flux creeping-up become more significant when plating with gold, tin, or the like is applied only to the surface of the contact portion 32c and plating having low wettability is applied to the remaining surfaces of the first contact 30.

The first insulator 20 includes the inner surface 28 adjacent to the recess 27 to be widened other than the vicinity of the exposed surface of the contact portion 32c of the first contact 30. Accordingly, even in a case where the second connector 50 as a connection target approaches the first connector 10 obliquely deviating from a normal fitting posture, part of the second connector 50 comes into contact with the inner surface 28 to reduce positional displacement of a contact point between the first connector 10 and the second connector 50. If the inner surface 28 is not provided, only the first contact 30 comes into contact with the second connector 50 even upon such oblique fitting to have difficulty in reduction of the positional displacement.

The contact portion 32c is positioned inside the outer peripheral wall 22 rather than the inner surface 28. Accordingly, the contact portion 73 of the second contact 70 more reliably comes into contact with the contact portion 32c positioned on the inner side when the second connector 50 is fitted to the first connector 10. More reliable contact between the contact portion 32c of the first contact 30 and the contact portion 73 of the second contact 70 enables reducing deterioration of contact reliability at the first contact 30.

In the connector module 1, the one second contact 70 is positioned between the pair of first contacts 30 and comes into contact with both the pair of first contacts 30 when the first connector 10 and the second connector 50 are fitted to each other. This facilitates size reduction of the entire connector module 1 in comparison to a conventional connector module in which a pair of second contacts 70 is disposed in the anteroposterior direction.

It is apparent to those skilled in the art that the present disclosure can be embodied in a predetermined mode other than the embodiment described above without departing from the spirit or the essential characteristics. Accordingly, the above description is exemplary and does not limit the present disclosure. The scope of disclosure is defined not by the above description but by the attached claims. Some of various changes within an equivalent range are assumed to be included therein.

For example, each the constituent portions described above is not limited to the contents of the above description or illustration in the figures in terms of shape, size, disposition, direction, and the number. The shape, size, disposition, direction, and the number of each of the constituent portions may be appropriately set as long as the constituent portion can achieve its function.

The method of assembling the first connector 10 and the second connector 50 described above is not limited to the contents of the above description. The first connector 10 and the second connector 50 may be assembled in accordance with any appropriate method as long as these can be assembled to exhibit respective functions. For example, in the first connector 10, the first metal part 40 may be formed integrally with the first insulator 20 by insert molding instead of press fitting. For example, in the second connector 50, at least one of the second contact 70 or the second metal part 80 may be attached to the second insulator 60 by press fitting instead of insert molding.

The above embodiment describes that the first contact 30 is formed integrally with the long wall 22b. However, the present disclosure is not limited to this case. The first contact 30 may alternatively be formed integrally with the short wall 22a. In this case, the contact portion 32c may be disposed along the short wall 22a instead of the long wall 22b, and may be positioned inside the short wall 22a. The recess 27 may be recessed from the inner surface of the short wall 22a instead of the long wall 22b.

The above embodiment describes that the contact portion 32c and the free end 32e in the first contact 30 are positioned on the identical side in the anteroposterior direction with respect to the long wall 22b. However, the present disclosure is not limited to this case. The contact portion 32c and the free end 32e are not necessarily positioned on the identical side in the first contact 30.

The above embodiment describes that the first insulator 20 is cut out due to provision of the recess 27 on each of the sides of the contact portion 32c in the array direction of the plurality of first contacts 30. However, the present disclosure is not limited to this case. Alternatively, the first insulator 20 may be cut out on at least one of the sides of the contact portion 32c in the array direction of the plurality of first contacts 30.

In the above embodiment, the first contact 30 includes the mount portion 31 formed into an L shape and extending outward from the outer surface of the outer peripheral wall 22. The first contact 30 includes the attachment portion 32 extending into an inverted U shape from the mount portion 31 oppositely from the circuit board CB1 and attached to the outer peripheral wall 22 from the outer surface to the inner surface of the recess 27. The first contact 30 includes the free end 32e positioned opposite to the mount portion 31 in the attachment portion 32, and the contact portion 32c positioned on the identical side of the free end 32e in the anteroposterior direction with respect to the long wall 22b in the attachment portion 32. The present disclosure has been described above, but is not limited to the above. The first contact 30 may alternatively have any appropriate shape as long as the first contact 30 is formed integrally with the outer peripheral wall 22 in the state where the contact portion 32c is disposed in the recess 27 and the first insulator 20 is cut out on each of the sides of the contact portion 32c.

The above embodiment describes that the free end 32e is exposed from the bottom surface facing the circuit board CB1 toward the circuit board CB1 in the first insulator 20. However, the present disclosure is not limited to this case. The free end 32e may alternatively be covered with the first insulator 20.

The above embodiment describes that the free end 32e is positioned opposite to the circuit board CB1 rather than the mount portion 31. However, the present disclosure is not limited to this case. The free end 32e may alternatively be positioned at a substantially identical position in the vertical direction to the circuit board CB1 in the same or a similar manner of the mount portion 31.

The above embodiment describes that the anteroposterior inner surface of the free end 32e is positioned substantially identically in the anteroposterior direction to the projecting tip of the contact portion 32c. However, the present disclosure is not limited to this case. The anteroposterior inner surface of the free end 32e may alternatively be positioned inside in the anteroposterior direction rather than the projecting tip of the contact portion 32c.

The above embodiment describes that the first contact 30 includes the recess 32d recessed from the contact portion 32c and the free end 32e. However, the present disclosure is not limited to this case. The first contact 30 does not necessarily include the recess 32d thus configured.

The above embodiment describes that the first insulator 20 includes the outer wall 26 extending in the region provided with the first contacts 30. However, the present disclosure is not limited to this case. The first insulator 20 does not necessarily include the outer wall 26 thus configured. The above embodiment describes that the outer wall 26 is disposed along the outer surface of the long wall 22b. However, the present disclosure is not limited to this case. The outer wall 26 may alternatively be disposed along the outer surface of the short wall 22a in a case where the first contact 30 is disposed on the short wall 22a.

The above embodiment describes that the first insulator 20 is formed to be anteroposteriorly wide on the inner surface 28 adjacent to the recess 27. However, the present disclosure is not limited to this case. The first insulator 20 is not necessarily formed to be anteroposteriorly wide on the inner surface 28. For example, the outer peripheral wall 22 may alternatively be formed to have a substantially constant width.

The above embodiment describes that the contact portion 32c is positioned inside the outer peripheral wall 22 rather than the inner surface 28. However, the present disclosure is not limited to this case. The contact portion 32c may alternatively be provided inside the outer peripheral wall 22 at a position closer to the outer peripheral wall 22 rather than the inner surface 28.

The above embodiment describes that the recess 27 is recessed anteroposteriorly outward by one step with respect to the inner surface 28. However, the present disclosure is not limited to this case. The recess 27 may alternatively be recessed by two or more steps.

The above embodiment describes that the one second contact 70 is positioned between the pair of first contacts 30 and comes into contact with both the pair of first contacts 30 when the first connector 10 and the second connector 50 are fitted to each other. However, the present disclosure is not limited to this case. The second connector 50 may alternatively include the pair of second contacts 70 that is positioned between the pair of first contacts 30 and respectively comes into contact with the pair of first contacts 30 when the first connector 10 and the second connector 50 are fitted to each other.

The above embodiment describes that the attachment portion 32 and the long wall 22b kept in the fitting state keep the postures while being obliquely inclined outward in the anteroposterior direction from below to above. However, the present disclosure is not limited to this case. The attachment portion 32 and the long wall 22b are not necessarily elastically deformed in a completely fitting state.

The above embodiment describes that three first contacts 30 are arrayed along one of the long walls 22b and the first connector 10 includes six first contacts 30 in total. However, the present disclosure is not limited to this case. The first connector 10 may alternatively include any appropriate number of first contacts 30.

In the above embodiment, the plurality of inner surfaces 28 arrayed along the long wall 22b has a constant first width in the anteroposterior direction. In the same or a similar manner, the long wall 22b has a constant second width in the anteroposterior direction at the plurality of recesses 27 arrayed along the long wall 22b. The first width is larger than the second width. Without being limited to the above configuration, the plurality of inner surfaces 28 may have varied first widths on the long wall 22b, the plurality of recesses 27 may have varied second widths, or both the first widths and the second widths may be varied.

For example, the long wall 22b may be formed to have at least one of the first width or the second width increased toward a lateral center. This enables reduction of deterioration of contact reliability at the first contacts 30 even in an exemplary case where the first connector 10 includes a larger number of first contacts 30 to have a further multipolar structure.

When the long wall 22b is formed to have at least one of the first width or the second width increased toward the center of the long wall 22b, the first insulator 20 can be reduced in elastic deformation volume at the center to achieve substantially constant elastic deformation volume along the long wall 22b. The first connector 10 can thus reduce deterioration of contact reliability at the first contact 30. Furthermore, when the elastic deformation volume is reduced at the center of the long wall 22b, the first connector 10 enables reduction of plastic deformation at the lateral center of the first insulator 20.

In the above description, the long wall 22b may be formed to have at least one of the first width or the second width increased toward the lateral center. However, the present disclosure is not limited to this case. The long wall 22b may alternatively be formed such that a lateral width of the inner surface 28 is larger than a lateral width of the long wall 22b in the recess 27 in addition to or in place of the first width and the second width. Still alternatively, the long wall 22b may be formed such that part of the outer peripheral wall 22 provided at an identical lateral position to the inner surface 28 has higher strength toward the lateral center of the long wall 22b. For example, the part may be formed into a trapezoidal shape in a top view. More specifically, the part may be formed into an inversely tapered shape such that a lateral width is increased from the inner side toward the outer side in the anteroposterior direction.

The first connector 10 and the connector module 1 configured as described above are equipped in an electronic device including the circuit board CB1 and the circuit board CB2. Examples of the electronic device include wearable devices such as a smart watch, a wireless earphone, and smart glasses, communication terminal devices such as a smartphone, and information processing devices such as a personal computer, a copier, a printer, a facsimile, and a multifunctional machine. The examples of the electronic device further include any appropriate industrial device.

Such an electronic device can reduce deterioration of contact reliability at the first contact 30 even in the case where the first contact 30 and the first insulator 20 are formed integrally in the first connector 10. Such an electronic device has excellent contact reliability at contacts including the first contact 30 and the second contact 70. This enhances product reliability of the electronic device.

The following concepts can be extracted from the present disclosure.
(1) A connector configured to be connected to a connection target, the connector including:

an insulator including a side wall of an outer peripheral wall and a first recess recessed from an inner surface of the side wall, and configured to be fitted to the connection target; and

a plurality of first contacts each including a contact portion positioned inside the side wall; in which

each of the first contacts is formed integrally with the side wall, the contact portion is disposed in the first recess, the insulator is cut out in an array direction of the plurality of first contacts with respect to the contact portion, and

each of the first contacts is elastically deformed integrally with the side wall when the connector and the connection target are fitted to each other.
(2) The connector according to (1) described above, in which

each of the first contacts includes a mount portion mounted on a circuit board and positioned at a first end of the first contact, and a free end as a second end opposite to the first end, and

the contact portion is positioned on an identical side of the free end in the first contact.
(3) The connector according to (2) described above, in which

each of the first contacts includes the mount portion having an L shape extending outward from an outer surface of the side wall, an attachment portion extending into an inverted U shape from the mount portion oppositely from the circuit board and attached to the side wall from the outer surface to an inner surface of the first recess, the free end positioned opposite to the mount portion in the attachment portion, and the contact portion positioned on an identical side of the free end in the attachment portion.
(4) The connector according to (2) or (3) described above, in which

the free end is exposed from a bottom surface facing the circuit board toward the circuit board in the insulator.
(5) The connector according to any one of (2) to (4) described above, in which

the free end is positioned opposite to the circuit board rather than the mount portion.
(6) The connector according to any one of (2) to (5) described above, in which

each of the first contacts includes a second recess positioned between the contact portion and the free end and recessed from the contact portion and the free end.
(7) The connector according to any one of (1) to (6) described above, in which the insulator includes an outer wall extending along an outer surface of the side wall in a region provided with the first contacts.
(8) The connector according to any one of (1) to (7) described above, in which

the contact portion is positioned inside the side wall rather than the inner surface of the side wall.
(9) A connector module including the connector according to any one of (1) to (8) described above, and the connection target configured to be connected to the connector.
(10) The connector module according to (9) described above, in which

the connector includes a pair of first contacts configured identically to the first contacts and disposed such that the contact portions face each other, and

the connection target includes a single second contact positioned between the pair of first contacts and coming into contact with both the pair of first contacts when the connector and the connection target are fitted to each other.
(11) An electronic device including the connector according to any one of (1) to (8) described above, or the connector module according to (9) or (10) described above.

### REFERENCE SIGNS

1 connector module
10 first connector (connector)
20 first insulator (insulator)
21 bottom plate
22 outer peripheral wall
22a short wall
22b long wall (side wall)
23 fitting recess
24 first contact retention groove
24a through portion
24b first recess
24c second recess
24d third recess
25 first metal part attachment portion
25a first wall portion
25b second wall portion
25c third wall portion
25d first attachment groove
25e second attachment groove
25f third attachment groove
26 outer wall
27 recess (first recess)
28 inner surface
30 first contact
31 mount portion
32 attachment portion
32a wide portion
32b curved portion
32c contact portion
32d recess (second recess)
32e free end
40 first metal part
41 first base
42 second base
43 projecting piece
44 first mount portion
45 first lock portion
46 contact portion
47 projecting piece
47a engaging portion
48 second lock portion
49 second mount portion
50 second connector (connection target)
60 second insulator
61 body
62 second contact retention groove
63 second metal part retention groove
70 second contact
71 mount portion
72 base
73 contact portion
80 second metal part
81 first mount portion
82 base
83 engaging portion
84 extending portion
85 wide portion
86 second mount portion
100 die
CB1 circuit board
CB2 circuit board

1. A connector configured to be connected to a connection target, the connector comprising:
an insulator including a side wall of an outer peripheral wall and a first recess recessed from an inner surface of the side wall, and configured to be fitted to the connection target; and
a plurality of first contacts each including a contact portion positioned inside the side wall; wherein
each of the first contacts is formed integrally with the side wall, the contact portion is disposed in the first recess, the insulator is cut out in an array direction of the plurality of first contacts with respect to the contact portion, and
each of the first contacts is elastically deformed integrally with the side wall when the connector and the connection target are fitted to each other.

2. The connector according to claim 1, wherein
each of the first contacts includes a mount portion mounted on a circuit board and positioned at a first end of the first contact, and a free end as a second end opposite to the first end, and
the contact portion is positioned on an identical side of the free end in the first contact.

3. The connector according to claim 2, wherein
each of the first contacts includes the mount portion having an L shape extending outward from an outer surface of the side wall, an attachment portion extending into an inverted U shape from the mount portion oppositely from the circuit board and attached to the side wall from the outer surface to an inner surface of the first recess, the free end positioned opposite to the mount portion in the attachment portion, and the contact portion positioned on an identical side of the free end in the attachment portion.

4. The connector according to claim 2, wherein
the free end is exposed from a bottom surface facing the circuit board toward the circuit board in the insulator.

5. The connector according to claim 2, wherein
the free end is positioned opposite to the circuit board rather than the mount portion.

6. The connector according to claim 2, wherein
each of the first contacts includes a second recess positioned between the contact portion and the free end and recessed from the contact portion and the free end.

7. The connector according to claim 1, wherein
the insulator includes an outer wall extending along an outer surface of the side wall in a region provided with the first contacts.

8. The connector according to claim 1, wherein
the contact portion is positioned inside the side wall rather than the inner surface of the side wall.

9. A connector module comprising:
the connector according to claim 1; and
the connection target configured to be connected to the connector.

10. The connector module according to claim 9, wherein
the connector includes a pair of first contacts configured identically to the first contacts and disposed such that the contact portions face each other, and
the connection target includes a single second contact positioned between the pair of first contacts and coming into contact with both the pair of first contacts when the connector and the connection target are fitted to each other.

11. An electronic device comprising the connector according to claim 1.

12. An electronic device comprising the connector module according to claim 9.
